(19) United States
(12) Patent Application Publication
(10) Pub. No.: US 2014/0041391 A1
(43) Pub. Date: Feb. 13, 2014

(54) APPARATUS INCLUDING A FLOW CONDITIONER COUPLED TO A TRANSITION PIECE FORWARD END

(71) Applicants: Richard Martin DiCintio, Simpsonville, SC (US); Wei Chen, Greer, SC (US)

(72) Inventors: Richard Martin DiCintio, Simpsonville, SC (US); Wei Chen, Greer, SC (US)

(73) Assignee: GENERAL ELECTRIC COMPANY, Greenville, SC (US)

(21) Appl. No.: 13/568,842

(22) Filed: Aug. 7, 2012

(51) Int. Cl. F02C 1/00; B23K 3/00

(52) U.S. Cl. 60/752; 29/888.012

(57) ABSTRACT

An apparatus is provided and includes a combustor, a transition piece and a flow conditioner. The combustor has a head end and defines a first flowpath along which a main flow is directable to flow in a downstream direction from the head end. The transition piece is disposable downstream from the combustor, has a forward end and defines a second flowpath along which the main flow is directable to flow in the downstream direction from the forward end. The flow conditioner includes an inner member coupled to the transition piece forward end, an outer member and aerodynamic elements supportively disposed between the inner and outer members to be interactive with a flow of fluid proceeding toward the combustor head end.

### BACKGROUND OF THE INVENTION

The subject matter disclosed herein relates to an apparatus including a flow conditioner connected to a transition piece forward end and a combustor liner.

In turbomachines, such as gas turbine engines, a compressor compresses inlet air and the compressed inlet air is mixed with fuel and combusted in a combustor. The products of the combustion flow through the combustor and into a transition piece before flowing into a turbine. Within the turbine, the products of the combustion interact with aerodynamic elements to generate mechanical energy. In some cases, injectors may be provided on the combustor near its aft end whereby an additional mixture of air and fuel can be injected toward the flow of the products of the combustion in order to reduce emissions of pollutants, such as oxides of nitrogen.

The compressed air is typically transported from the compressor to the combustor in a reverse-flow direction and it has been found that such transportation often leads to circumferentially non-uniform flows. These non-uniform flows negatively affect combustor performance and may lead to un-predictable flame holding and emissions results. The non-uniform flows may also result in uneven cooling on the combustor liner and, therefore, reductions of combustor life.

### BRIEF DESCRIPTION OF THE INVENTION

According to an aspect of the invention, an apparatus is provided and includes a combustor, a transition piece and a flow conditioner. The combustor has a head end and defines a first flowpath along which a main flow is directable to flow in a downstream direction from the head end. The transition piece is disposable downstream from the combustor, has a forward end and defines a second flowpath along which the main flow is directable to flow in the downstream direction from the forward end. The flow conditioner includes an inner member coupled to the transition piece forward end, an outer member and aerodynamic elements supportively disposed between the inner and outer members to be interactive with a flow of fluid proceeding toward the combustor head end.

According to another aspect of the invention, an apparatus is provided and includes a combustor, an injector, a transition piece and a flow conditioner. The combustor has a head end and an aft end and defines a first flowpath along which a main flow is directable to flow in a downstream direction from the head end toward the aft end. The injector is disposable proximate to the combustor aft end such that at least one of air and fuel are injectable toward the main flow. The transition piece is disposable downstream from the combustor, has a forward end and defines a second flowpath along which the main flow is directable to flow in the downstream direction from the forward end. The flow conditioner includes an inner member coupled to the transition piece forward end, an outer member and aerodynamic elements supportively disposed between the inner and outer members to be interactive with a flow of fluid proceeding toward the combustor head end and the injector.

According to yet another aspect of the invention, a method of assembling an apparatus is provided and includes determining a fluid mal-distribution profile of a turbomachine, forming a flow conditioner to include an inner member, an outer member and aerodynamic elements arranged in accordance with the determined profile and interposing the flow conditioner between a combustor and a transition piece of the turbomachine.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a turbomachine;

FIG. 2 is a perspective view of a flow conditioner;

FIG. 3 is a radial view of an aerodynamic element of the flow conditioner of FIG. 2; and

FIG. 4 is an axial view of a distribution of aerodynamic elements of the flow conditioner of FIG. 2.

The detailed description explains embodiments of the invention, together with advantages and features, by way of example with reference to the drawings.

### DETAILED DESCRIPTION OF THE INVENTION

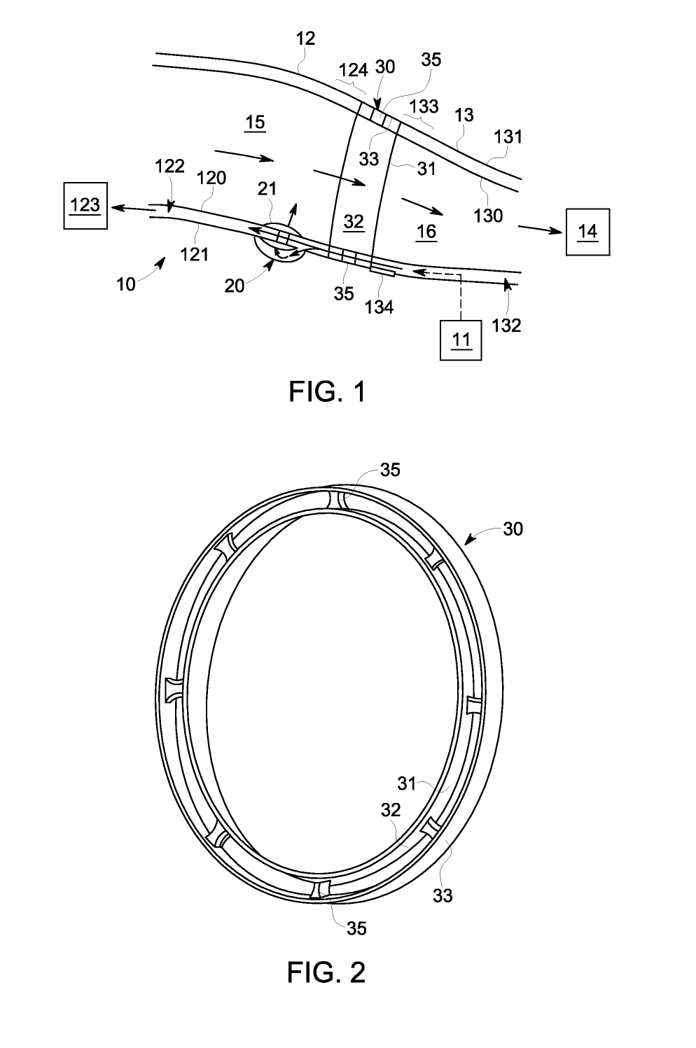

With reference to FIG. 1, an apparatus, such as a turbomachine 10, is provided. The turbomachine 10 includes a compressor 11, a combustor 12 having a head end 123, a transition piece 13 and a turbine 14. The turbomachine 10 may further include axially staged injectors 20 (e.g., late lean injectors) disposed on the combustor 12. The compressor 11 compresses inlet air, which is transported to the combustor 12 and mixed with fuel to form a fuel/air mixture. This fuel/air mixture is then combusted within a combustion zone defined in an interior of the combustor 12 to produce a main flow of working fluid. The working fluid is directed to flow as the main flow along a first flowpath 15 defined within the combustor 12 in a downstream direction from the head end 123 and toward the transition piece 13. Upon reaching the transition piece 13, the main flow of the working fluid is directed to flow through the transition piece 13 and toward the turbine 14 along a second flowpath 16 defined within the transition piece 13. Within the turbine 14, the working fluid may be expanded for power generation operations.

As shown in FIG. 1, the combustor 12 includes a combustor liner 120, which is substantially annular in shape. The combustor liner 120 is formed to define the combustion zone and the first flowpath 15 therein. The combustor 12 further includes a flow sleeve 121 disposed around the combustor liner 120 to define a first annulus 122 and the head end 123. The head end 123 is disposed upstream from the combustion zone relative to the downstream direction of the main flow of the working fluid and includes various nozzles and fuel injectors configured to inject the fuel/air mixture into the combustion zone.

The transition piece 13 is disposed fluidly downstream from the combustor 12 and includes a transition piece liner 130 and an impingement sleeve 131. The transition piece liner 130 is formed to define the second flowpath 16 therein. The impingement sleeve 131 is formed to define a series of impingement holes and is disposed around the transition piece liner 130 to define a second annulus 132.

Inlet air that is compressed by the compressor 11 is exhausted into a compressor discharge casing (CDC). The compressed air then flows from the CDC toward the impingement sleeve 131. At this point, the compressed air passes through the impingement holes of the impingement sleeve 131 and impinges upon the transition piece liner 130. The compressed air then travels upstream via the second annulus 132 and enters and passes through the first annulus 122 before reaching the head end 123. Within the head end, the compressed air is mixed with the fuel to form the fuel/air mixture and is redirected into the combustion zone.

Being disposed fluidly downstream from the combustor 12, the transition piece 13 includes a forward end 133 that is configured to be disposed proximate to an aft end 124 of the combustor 12 such that the first flowpath 15 generally leads into the second flowpath 16. A flow conditioner 30 is fluidly interposed between the forward end 133 of the transition piece 13 and the aft end 124 of the combustor 12. In accordance with embodiments, the flow conditioner 30 may include a cast or otherwise monolithic body 31 that is at least partially coupled or connected (e.g., welded) to the forward end 133 of the transition piece 13 and to the aft end 124 of the combustor 12.

With reference to FIGS. 1 and 2, the body 31 of the flow conditioner 30 includes an inner member 32, an outer member 33 and aerodynamic elements 35. The inner member 32 may be substantially annular in shape. In some cases, a shape of the aft side of the inner member 32 may be substantially similar to the shape of the transition piece liner 130 at the forward end 133 of the transition piece 13. Similarly, a shape of the forward side of the inner member 32 may be substantially similar to the shape of the combustor liner 120 at the aft end 124 of the combustor 12. In this way, a smooth transition from the first flowpath 15 to the second flowpath 16 may be provided. In accordance with further embodiments, the inner member 32 may be welded to the transition piece liner 130 at the forward end 133 of the transition piece and to the combustor liner 120 at the aft end 123 of the combustor 12.

The outer member 33 is disposed to surround the inner member 32. Thus, a shape of the outer member 33 may mimic the shape of the inner member 32 or have a dissimilar shape from the inner member 32. In some cases, a shape of the aft side of the outer member 32 may be substantially similar to the shape of the impingement sleeve 131 at the forward end 133 of the transition piece 13. Similarly, a shape of the forward side of the outer member 33 may be substantially similar to the shape of the flow sleeve 121 at the aft end 124 of the combustor 12. In this way, a smooth transition from the second annulus 132 to the first annulus 122 may be provided. In accordance with further embodiments and, as shown in FIG. 1, the outer member 33 may be coupled or otherwise connected to an extension ring 134 disposed at the forward end 133 of the transition piece 13. The outer member 33 may also be coupled or otherwise connected to the flow sleeve 121 at the aft end 124 of the combustor 12.

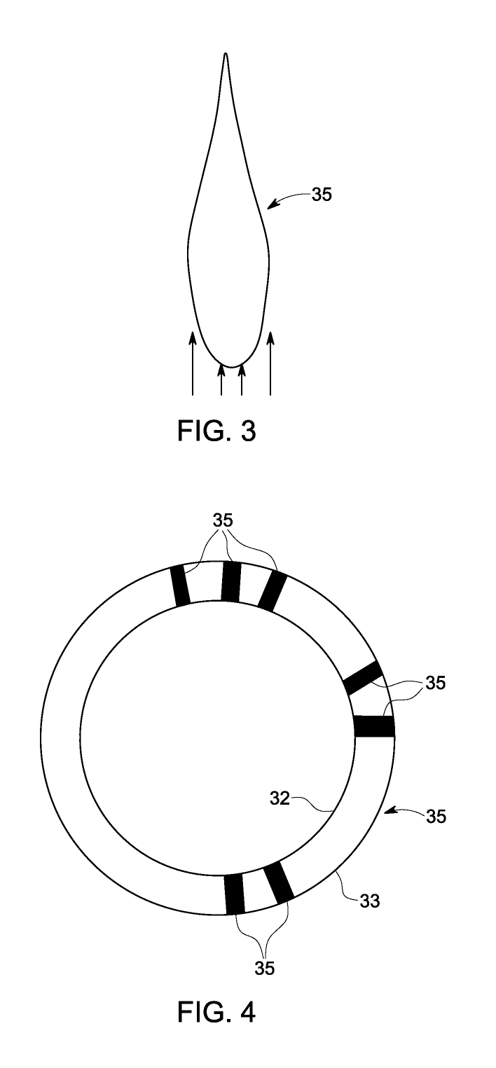

The aerodynamic elements 35 are supportively disposed between the inner member 32 and the outer member 33. In this position, the aerodynamic elements 35 aerodynamically interact with a flow of fluid (e.g., the compressed gas) proceeding from the second annulus 132 to the first annulus 122 and toward the head end 123 of the combustor 12. With reference to FIG. 3, one or more of the aerodynamic elements 35 may be teardrop-shaped with a bulbous leading end and a tapered trailing end defined in relation to a direction of the flow of fluid. In accordance with further embodiments, the aerodynamic elements 35 may be airfoil-shaped and/or angled with respect to a central axis of the turbomachine 10 to impart swirl to the flow of fluid.

With reference to FIG. 4, the aerodynamic elements 35 may be arranged in a substantially uniform circumferential array with a substantially uniform distribution around the inner member 32. In accordance with alternative embodiments, as shown in FIG. 4, the aerodynamic elements 35 may be arranged in a non-uniform circumferential array with a non-uniform distribution around the inner member 32. In such alternative embodiments, the distribution of the aerodynamic elements 35 may be determined in accordance with a measured mal-distribution profile of fluid moving through the turbomachine 10. This measured mal-distribution profile may be arrived at or calculated by way of computation fluid dynamics (CFD) or another similar type of analysis.

Where the compressed air proceeding from the second annulus 132 to the first annulus 122 is found to be mal-distributed, the aerodynamic elements 35 may be disposed to at least partially correct the mal-distribution. That is, if the compressed air tends to concentrate on one side of the turbomachine 10 in an exemplary case, the aerodynamic elements 35 may be generally provided on that one side to encourage flows of a portion of the compressed air toward the other side of the turbomachine 10.

In a case where the turbomachine 10 further includes the axially staged injectors 20, the axially staged injectors 20 may be provided as mushroom-style injectors 21 and are disposed on the combustor 12 proximate to the aft end 124 of the combustor 12. In this position, the axially staged injectors 20 permit an injection of air and/or fuel toward the main flow of the working fluid proceeding along the first flowpath 15. At least a portion of the air that is injectable by the axially staged injectors 20 may be drawn from the compressed air proceeding from the second annulus 132 to the first annulus 122. Thus, the aerodynamic elements 35 are disposed upstream from the axially staged injectors 20 and an arrangement of the aerodynamic elements 35 may be defined such that an air shield normally required for axially staged injectors 20 can be removed and such that a flow of fluid to the axially staged injectors 20 is substantially uniform.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus, comprising:
a combustor having a head end and defining a first flowpath along which a main flow is directable to flow in a downstream direction from the head end;
a transition piece, which is disposable downstream from the combustor, the transition piece having a forward end and defining a second flowpath along which the main flow is directable to flow in the downstream direction from the forward end; and
a flow conditioner including an inner member coupled to the transition piece forward end, an outer member and aerodynamic elements supportively disposed between the inner and outer members to be interactive with a flow of fluid proceeding toward the combustor head end.

2. The apparatus according to claim 1, wherein the flow conditioner comprises a cast body.

3. The apparatus according to claim 1, wherein the inner member is welded to the transition piece forward end.

4. The apparatus according to claim 1, wherein the inner and outer members each comprise an annular member.

5. The apparatus according to claim 1, wherein the inner and outer members are dissimilar.

6. The apparatus according to claim 1, wherein the outer member is coupled to an extension ring of an impingement sleeve of the transition piece.

7. The apparatus according to claim 1, wherein the aerodynamic elements are each teardrop-shaped.

8. The apparatus according to claim 1, wherein the aerodynamic elements are arranged in a non-uniform circumferential array.

9. An apparatus, comprising:
a combustor having a head end and an aft end and defining a first flowpath along which a main flow is directable to flow in a downstream direction from the head end toward the aft end;
an injector disposable proximate to the combustor aft end by which at least one of air and fuel are injectable toward the main flow;
a transition piece, which is disposable downstream from the combustor, the transition piece having a forward end and defining a second flowpath along which the main flow is directable to flow in the downstream direction from the forward end; and
a flow conditioner including an inner member coupled to the transition piece forward end, an outer member and aerodynamic elements supportively disposed between the inner and outer members to be interactive with a flow of fluid proceeding toward the combustor head end and the injector.

10. The apparatus according to claim 9, wherein the flow conditioner comprises a cast body.

11. The apparatus according to claim 9, wherein the inner member is welded to the transition piece forward end.

12. The apparatus according to claim 9, wherein the inner and outer members each comprise an annular member.

13. The apparatus according to claim 9, wherein the inner and outer members are dissimilar.

14. The apparatus according to claim 9, wherein the outer member is coupled to an extension ring of an impingement sleeve of the transition piece.

15. The apparatus according to claim 9, wherein the aerodynamic elements are each teardrop-shaped.

16. The apparatus according to claim 9, wherein the aerodynamic elements are arranged in a non-uniform circumferential array.

17. A method of assembling an apparatus, comprising:
determining a fluid mal-distribution profile of a turbomachine;
forming a flow conditioner to include an inner member, an outer member and aerodynamic elements arranged in accordance with the determined profile; and
interposing the flow conditioner between a combustor and a transition piece of the turbomachine.

18. The method according to claim 17, wherein the determining comprises conducting computational fluid dynamics (CFD) calculations.

19. The method according to claim 17, wherein the interposing comprises welding the inner member to a forward end of the transition piece.

20. The method according to claim 17, further comprising coupling an extension ring of an impingement sleeve of the transition piece to the outer member.
